(19) United States
(12) Patent Application Publication
(10) Pub. No.: US 2001/0043191 A1
(43) Pub. Date: Nov. 22, 2001

(54) AUDIO AND VIDEO CONTROLS ON A POINTING DEVICE FOR A COMPUTER

(76) Inventor: TODD D. LINDSEY, SIOUX CITY, IA (US)

Correspondence Address: SCHWEGMAN LUNDBERG WOESSNER AND KLUTH, P O BOX 2938, MINNEAPOLIS, MN, 55402

(21) Appl. No.: 08/904,056

(22) Filed: Jul. 31, 1997

(51) Int. Cl. G09G 5/08

(52) U.S. Cl. 345/163

(57) ABSTRACT

A pointing device having computer multimedia (audio and video) controls is disclosed. In one embodiment of the invention, a computerized system comprises a computer, a multimedia device and a pointing device. The pointing device has at least one control to control the multimedia device, such as the volume of the device. Actuation of a control causes the computer to change a functionality of the multimedia device associated with the control.

### FIELD OF THE INVENTION

This invention relates generally to a pointing device for a computer, and more particularly to such a pointing device having computer audio and/or video controls.

### BACKGROUND OF THE INVENTION

Because of the growing interest in multimedia applications for computers, computers typically now come installed with at least one audio and/or video (i.e., multimedia) device. At a minimum, a computer usually has a speaker to play audio clips, or is coupled to a monitor that has a speaker. More sophisticated computers include stand-alone stereo speakers. Compact-disc read-only-memory (CD-ROM) drives are also common, and allow computer users to play audio and video which reside on CD-ROMs inserted into the drive. Still other computers include integrated radio audio and television tuners, so that radio audio, and television audio and video, can be used in conjunction with the computer.

Each of these multimedia devices is associated with one or more controls. For example, a set of stand-alone speakers, or speakers integrated into a computer monitor, have at a minimum a volume control, and may also have bass and treble controls. CD-ROM drives usually permit the playing of audio compact discs (CDS) as well, and therefore have an assortment of controls such as play, fast-forward, fast-backward, next track, previous track, stop, etc. Radio and television tuners include controls for changing the station or channel of the tuner.

For ease of use considerations, computer manufacturers typically include separate physical buttons for these controls on the multimedia device itself. This is not always convenient for the computer user, however. Speakers, for example, may be located in positions not easily reached from the user's sitting position at the computer. This means that in order to change the volume, the user has to first stand up and walk to the speakers. In many home configurations, the computer monitor is located across the room from where the user sits, also necessitating the user to stand up and walk to the monitor to change the volume. Even CD-ROM drives, and radio and television tuners, are frequently located such that they are not conducive to easy use of their controls.

A limited prior art solution is the inclusion of software audio controls. For example, a control panel in the Microsoft Windows 95 operating system may specifically be provided to control the multimedia device. However, software audio controls may be inconvenient to the user. For example, to utilize the audio controls control panel, the user is required to first call up the control panel by first opening the control panels folder, and then opening the audio controls control panel. This is also time-consuming, which prevents the software audio controls from being quickly and easily used when an external event, such as the ringing of a nearby phone, requires immediate attention. That is, when the phone rings, the user desires to immediately turn down the volume of the speakers of a computer, but software audio controls to not permit the user to easily accomplish this task.

Another limited prior art solution is the wireless remote control device. For example, such a device may permit a user to press one particular button to decrease the volume of an associated device, and press another particular button to increase the volume of the associated device. However, remote controls are easily lost by the computer user. Furthermore, in many cases each different device (a CD-ROM player, a set of speakers, a television tuner, a radio tuner, etc.) may have its own separate remote control. Thus, to control any given device, the user first has to find the right remote control, which may be inconvenient.

There is a need, therefore, for more convenient control of multimedia devices for computers. There is a need for the controls for these devices to be positioned closer to the computer user, so that the user does not have to stand up and walk to a multimedia device in order to change its controls.

### SUMMARY OF THE INVENTION

The above-mentioned shortcomings and problems are addressed by the present invention, which will be understood by reading and studying the following specification. The invention describes a pointing device for a computer having audio and/or video (i.e., multimedia) controls. The controls permit a user of the computer to control a multimedia device coupled to the computer, such as the volume, current channel in the case of a radio or television tuner, or the current track in the case of a CD-ROM player.

In this manner, the present invention provides for more convenient control of multimedia devices. Regardless of where these devices are located, the user of the computer is nearly always situated near a pointing device for a computer, since frequent use of the pointing device is usually necessary in order to use the computer. Therefore, having the multimedia controls on the pointing device itself means that the user does not have to stand up and walk to a multimedia device in order to change its controls.

In differing embodiments, a computerized system and a pointing device according to the principles of the invention are described. Still other and further aspects, advantages and embodiments of the present invention will become apparent by reference to the drawings and by reading the following description.

### BRIEF DESCRIPTION OF THE DRAWINGS

FIG. 1(a) is a diagram of a mouse pointing device according to one embodiment of the invention;

FIG. 1(b) is a diagram of a mouse pointing device according to another embodiment of the invention;

FIG. 2 is a block diagram of a computerized system according to one embodiment of the invention; and,

FIG. 3 is a block diagram of a typical computer in conjunction with which a pointing device according to an embodiment of the invention is utilized.

### DETAILED DESCRIPTION OF THE INVENTION

In the following detailed description of the preferred embodiments, reference is made to the accompanying drawings which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the appended claims.

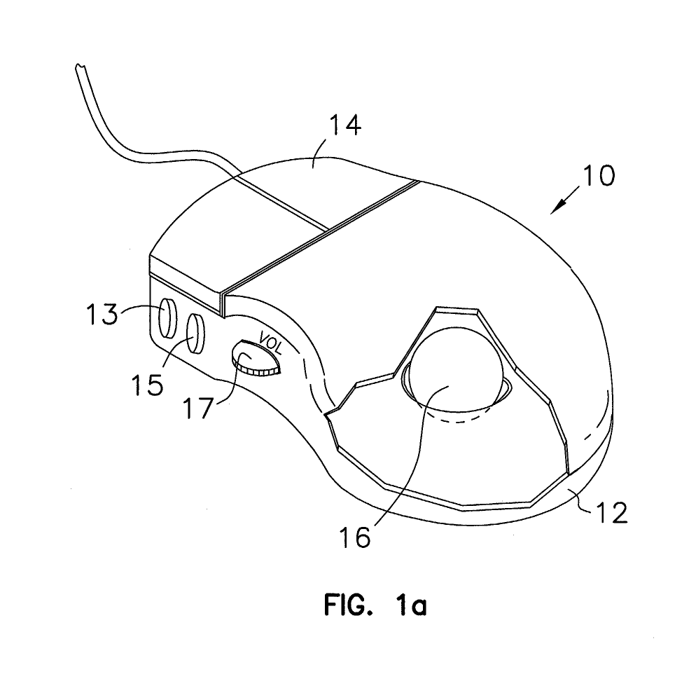

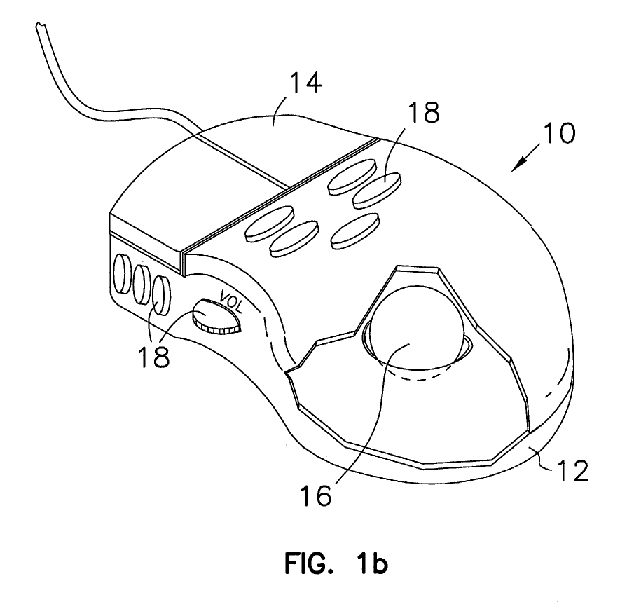

Referring first to FIG. 1(a), a diagram of a mouse pointing device according to one embodiment of the invention is shown. Mouse pointing device 10 is a typical pointing device in conjunction with which an embodiment of the present invention may be implemented. However, the invention is not so limited. Other pointing devices amenable to the present invention include a touch pad, a trackball, a joystick, and a wheel.

Mouse pointing device 10 includes housing 12, in which is disposed mouse buttons 14 and sensor ball 16. Sensor ball 16 is specifically disposed within a cavity of housing 12, as is shown in FIG. 1(a). Mouse buttons 14 are so called regardless of whether pointing device 10 is a mouse or other type of pointing device. Actuation of any of mouse buttons 14 is communicated to a computer to which pointing device 10 is coupled. For example, in a computer running a Microsoft Windows operating system such as Microsoft Windows 95, actuating the left mouse button causes selection of the object underneath a pointer on a screen of the computer, and actuating the right mouse button causes a contextual menu to pop up at the current position of the pointer. The invention is not so limited.

Sensor ball 16 is a component to permit pointing device 10 to signal directional movement to the computer to which pointing device 10 is coupled. When pointing device 10 is moved across a horizontal surface, sensor ball 16 rotates within its cavity in housing 12. This relative movement is then communicated to the computer, by sensors (not shown in FIG. 1(a)) that detect rotation of the ball within its cavity in the housing. For example, in a computer running a Microsoft Windows operating system, moving pointing device 10 causes corresponding movement of a pointer on the screen of the computer. Components for mouse pointing devices which include sensors and sensor balls are well known to those skilled in the art; mouse pointing devices provided with most home and business PC-compatible computer systems include such components. However, the invention is not limited to a sensing mechanism including a sensor ball 16. For example, other mouse pointing devices are optical in nature, and include optical sensors that detect the number of lines of a grid over which the mouse has been moved. For further example, touch pad pointing devices include a touch-sensitive pad upon which relative movement is detected.

Mouse pointing device 10 of FIG. 1(a) specifically includes three multimedia controls: next button 13, previous button 15, and volume wheel 17. Pressing the next button 13 causes a corresponding multimedia device, such as a CD-ROM device, or a television or radio tuner device, to proceed to the next track or channel, etc. For example, in the case of a CD-ROM device, pressing button 13 causes the device to jump to the next track of the compact disc inserted therein, while in the case of a tuner device, pressing button 13 causes the device to tune to the next channel. Conversely, pressing the previous button 15 causes the corresponding multimedia device to proceed to the previous track or channel, etc. Finally, volume wheel 17 is controlled such that when it is turned in one direction the volume of the corresponding multimedia device is increased, while when it is turned in the opposite direction the volume is decreased.

However, the invention is not so limited to the controls specifically shown in FIG. 1(a). To generalize, reference is made to FIG. 1(b), which is a diagram of a mouse pointing device according to another embodiment of the invention. Mouse 10 of FIG. 1(b) is identical to mouse 10 of FIG. 1(a), except that buttons 13 and 15, and wheel 17, have been replaced by a plurality of controls identified by reference number 18. Mouse pointing device 10 thus includes one or more multimedia controls 18 disposed within housing 12 of pointing device 10. Buttons 13 and 15, and wheel 17, of the mouse pointing device of FIG. 1(a) are one specific implementation of controls 18; the invention is not so limited.

Still referring to FIG. 1(b), multimedia controls 18 permit a user to control a multimedia device, such as a CD-ROM drive, a radio or television tuner, or an amplifier coupled to one or more speakers. For example, in the case of a CD-ROM drive, which is one type of optical drive, the drive is able to play audio compact discs, and may have such functionality as play, stop, next-track, previous-track, fast-forward, and fast-backward. In the case of a tuner, the functionality may include next station or channel, previous station or channel, scan up the frequencies, scan down the frequencies, as well as one or more preset stations or channels. Finally, in the case of an amplifier coupled to one or more speakers, the functionality may include decreasing the volume, and increasing the volume, as well as increasing and decreasing treble and/or bass.

In one embodiment, each control 18 is a button, although the invention is not so limited. That is, control 18 may also be a wheel, a slider, or any other type of control. Actuation of a control 18 causes the computer to which pointing device 10 is coupled to change the functionality associated with the control 18. For example, in the case where the multimedia device is a set of speakers, pressing a control corresponding to decreasing the volume of the multimedia device causes the computer to decrease the volume of the sound heard from the speakers. Similarly, pressing a control corresponding to increasing the volume of the multimedia device causes the computer to increase the volume of the sound heard from the speakers.

The present invention therefore provides for more convenient control of multimedia devices. For example, in the case just described, where the multimedia device is a set of speakers, the speakers may not always be close to where a user of the computer is. However, the pointing device is most likely near the user, because the user needs to use the pointing device frequently in order to use the computer. Therefore, a pointing device including the multimedia controls for the speaker—in this case, volume controls—is more convenient for the user, and means that the user does not have to stand up and walk to the speakers in order to change their volume. Similarly, a pointing device including the controls for other multimedia devices, such as a radio or television tuner, is also more convenient for a user of the computer.

Furthermore, the invention provides for more convenient control of multimedia devices than does limited prior art solutions such as software audio controls. Unlike software audio controls, the controls of the present invention are immediately accessible to the user. Thus, for example, when the user is interrupted by a ringing telephone, he or she is immediately able to decrease the volume of the speakers of the computer, as opposed to having to find the software audio controls program, load the program, and then finally decrease the volume of the speakers using the program.

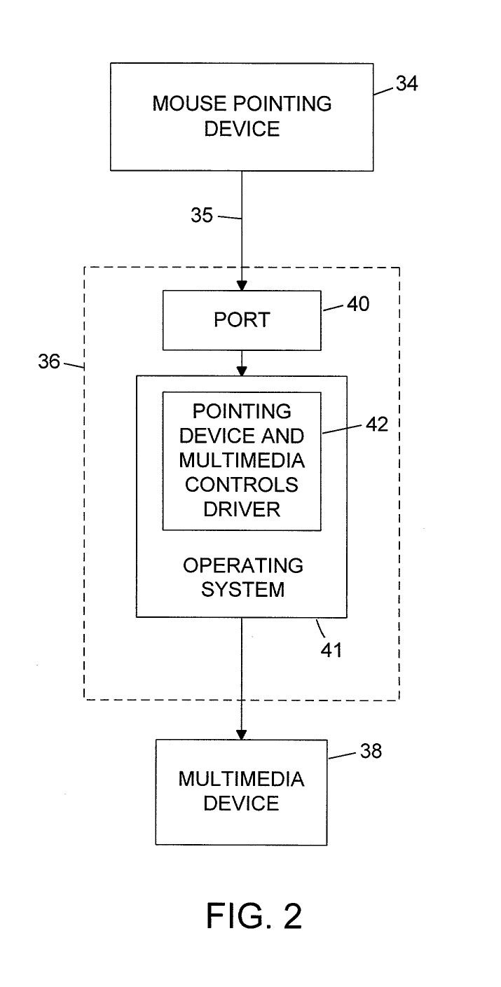

Referring now to FIG. 2, a block diagram of a computerized system according to another embodiment of the invention. In this embodiment of the invention, both multimedia control information as well as information regarding mouse button actuation and directional movement of the pointing device is received at the same port of the computer. Mouse pointing device 34 is operatively coupled to computer 36, which is operatively coupled to multimedia device 38. Mouse pointing device 34 corresponds to mouse pointing device 10 of FIG. 1(a) and FIG. 1(b), and reference should be made to the description in conjunction with pointing device 10 of FIG. 1(a) and FIG. 1(b) for further understanding thereto. Mouse pointing device 20 includes multimedia controls as well as mouse buttons. The invention is not limited to any particular pointing device.

Mouse pointing device 34 is coupled to computer 36 as represented by element 35. The invention is not limited to a particular implementation of element 35. In one embodiment, element 35 represents a wireless connection between mouse pointing device 34 and computer 36, in which case each of device 34 and computer 36 includes a radio frequency (RF) transceiver to communicate with the other transceiver. The transceiver for computer 36 is plugged into port 40, or replaces port 40. In another embodiment, element 35 represents a serial cable of mouse pointing device 34 plugging into port 40, which is a serial port. In another embodiment, element 35 represents a Universal Serial Bus (USB) cable of mouse pointing device 34 plugging into port 40, which is a USB port.

Computer 36 is preferably a PC-compatible computer running a version of the Microsoft Windows operating system as operating system 41; however, the invention is not so limited. Only the elements of computer 36 that are necessary to show and describe the operation of the embodiment of the invention of FIG. 2 are shown; those skilled in the art will recognize that computer 36 typically includes many other elements. Multimedia device 38 is any such device having functionality that is controllable. Such devices include a CD-ROM drive, a television or radio tuner, and an amplifier coupled to one or more speakers, as has been described. The invention is not limited to any particular multimedia device 38.

Pointing device 34 has at least one control to control multimedia device 38, such that actuation of a control causes computer 36 to change a functionality associated with the control. Pointing device 34 sends information regarding the actuation of the multimedia controls to driver 42 through port 40. Port 40 also receives information from pointing device 34 regarding the actuation of one or more of the mouse buttons of pointing device 34, as well as relative directional movement of pointing device 34. Thus, all communication between pointing device 34 and computer 36 occurs through port 40. Specifically, packetized data regarding the actuation of the multimedia controls, as well as the actuation of one or more of the mouse buttons and relative directional movement of the pointing device, is sent over serial cable 35 to computer 36 through port 40.

Pointing device and multimedia controls driver 42 interprets both information regarding directional movement and mouse button actuation of pointing device 34, as well as actuation of one or more of the multimedia controls of mouse pointing device 34. Driver 42 is a part of operating system (OS) 41, such as a version of Microsoft Windows as known within the art. The information interpreted by driver 42 regarding directional movement and mouse button actuation of pointing device 34 is used to move a pointer on the screen of the computer (not shown in FIG. 2) correspondingly to movement of pointing device 34, and to select objects on the screen in response to actuation of a mouse button. Furthermore, driver 42 detects the actuation of the multimedia controls received at port 40, and in response controls multimedia device 38.

Specifically, the packetized data at port 40 is received by driver 41 of operating system 41. Driver 41, as known within the art, unpacketizes the data, and interprets the information contained therein. In particular, driver 41 determines whether the information in a particular data packet pertains to one or more of multimedia control actuation information, mouse button actuation information, or pointing device movement information. Driver 41 then performs the appropriate action based on this information. For example, if an increase-volume control is actuated on mouse pointing device 34, information regarding this actuation is received by the computer at port 40. Driver 42 interprets this information, and increases the volume of multimedia device 38 correspondingly.

The invention is not limited to any particular implementation of pointing device and multimedia controls driver 42. In one embodiment, the driver is implemented on a computer running the Microsoft Windows 95 operating system as operating system 41, and therefore is accessible by access to the control panels menu item on the start menu. Pointing device drivers for computers capable of running Microsoft Windows are well known to those of ordinary skill in the art. U.S. patent application Ser. No. 08/724357, filed Oct. 1, 1996, and entitled “Pointing Device with Control for Adjusting Sensitivity,” provides a discussion of such a mouse driver program. “The Indispensable PC Hardware Book,” by Hans-Peter Messmer (2d ed. 1995, ISBN 0-201-87697-3) also provides information regarding pointing device drivers. Both of these references are hereby incorporated herein by reference.

The embodiment shown in FIG. 2 operates as follows. Actuation of a multimedia control on pointing device 34 is received by computer 36 at jack 40 and interpreted by driver 42. Driver 42 in response controls an associated functionality of multimedia device 38, such as increasing the volume of the device, decreasing the volume of the device, etc. Actuation of a mouse button of pointing device 34 and movement of pointing device 34 are also received by computer 34 at port 40 and interpreted by driver 42. In a graphical user interface such as Microsoft Windows, a pointer on the screen is then made to move in a corresponding manner, and an object on the screen is selected in response to the actuation of a mouse button.

The advantage to the computerized system of FIG. 2 is that mouse pointing device 34 only couples the computer at port 40. Because prior art computers typically have at least one such port (e.g., a USB port, or a serial port), no additional ports or jacks on such a computer are required to modify the computer according to the present invention. This is advantageous because many computers have a very limited number of such ports and jacks, and may not have any that are not already being used by other computer peripherals. Furthermore, many such computers are not capable of expansion, necessitating that the pointing device only use the one serial port currently allocated for it.

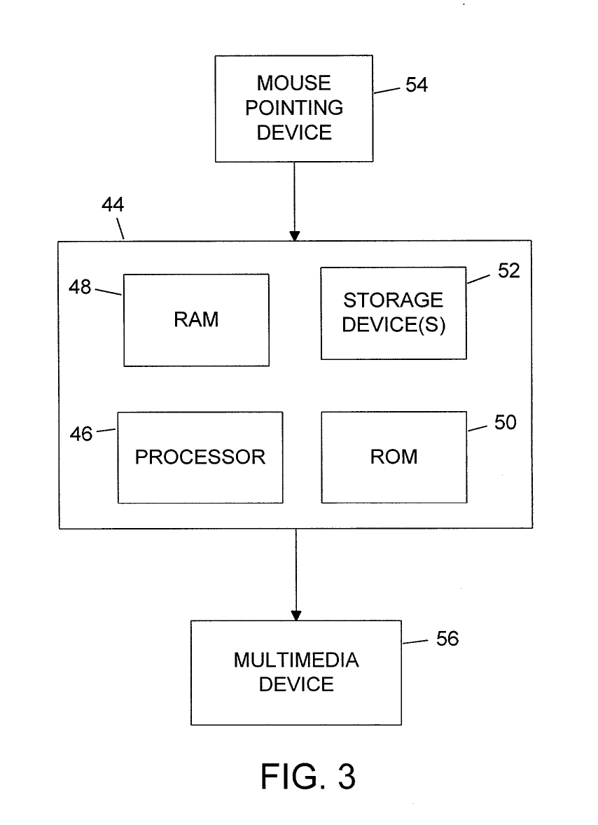

Referring now to FIG. 3, a block diagram of a typical computer in conjunction with which a pointing device according to an embodiment of the invention may be utilized is shown. Computer 44 includes processor 46 (preferably, an Intel Pentium processor), which is operatively coupled to random-access memory (RAM) 48 (preferably, at least sixteen megabytes of RAM), read-only memory (ROM) 50, and one or more storage devices 52, such as a hard disk drive, a floppy disk drive, or a tape cartridge drive, although the invention is not so limited. Mouse pointing device 54 is operatively coupled to computer 44. Mouse pointing device 54 is any type of pointing device according to the present invention, such as the mouse pointing device shown in and described in conjunction with FIG. 1(a) and FIG. 1(b). Computer 44 is also operatively coupled to multimedia device 56, such as a CD-ROM drive, a radio or television tuner, or speakers coupled to an amplifier. In other embodiments the multimedia device is integrated into the computer itself.

Mouse pointing device 54 acts to control multimedia device 56, as well as to control a pointer on the screen of a display device coupled to computer 44 (not shown in FIG. 3), in the case where computer 44 is running an operating system having a graphical user interface. For example, pressing a decrease-volume control button on mouse pointing device 54 causes computer 44 to lower the volume of the sound emanating from multimedia device 56. For further example, moving the mouse to the left causes a corresponding movement of a pointer on the screen of the display device coupled to computer 44, and clicking a left-mouse button on the pointing device 54 causes the computer to select the object underneath the pointer on the screen.

The invention is not limited to the types of controls included within mouse pointing device 54 to control multimedia device 56. Such controls include buttons, wheels, sliders, etc. For example, in one embodiment, a separate button is provided to increase the volume of a speaker that is device 56, and a separate button is provided to decrease the volume of the speaker. In another embodiment, the volume of the speaker is controlled by moving a slider or rotating a wheel in one direction to increase the volume, and in another direction to decrease the volume.

The functionality of multimedia device 56 controlled by pointing device 54 varies with the type of device 56. For example, in the case of a CD-ROM drive, which is one type of optical drive, the drive is able to play audio compact discs, and may have such functionality as play, stop, next-track, previous-track, fast-forward, and fast-backward. In the case of a tuner, the functionality may include next station or channel, previous station or channel, scan up the frequencies, scan down the frequencies, as well as directly addressing one of one or more preset stations or channels. Finally, in the case of an amplifier coupled to one or more speakers, the functionality may include decreasing the volume, and increasing the volume, as well as increasing and decreasing treble and/or bass.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. For example, the invention has been shown in relation to a pointing device which is a mouse. However, any pointing device is amenable to the invention, as those skilled in the art will appreciate. Therefore, it is manifestly intended that this invention be limited only by the following claims and equivalents thereof.

I claim:

1. A computerized system comprising:
a computer having at least a processor and a memory;
a multimedia device operatively coupled to the computer; and,
a pointing device operatively coupled to the computer and having at least one control to control the multimedia device.

2. The computerized system of claim 1, wherein actuation of a control causes the computer to change a functionality of the multimedia device associated with the control.

3. The computerized system of claim 1, wherein at least one of the at least one control comprises a control selected from the group of controls consisting of a button, a slider, and a wheel.

4. The computerized system of claim 1, wherein the pointing device is selected from the group of pointing devices comprising a mouse, a touch pad, a trackball, and a joystick.

5. The computerized system of claim 1, wherein the multimedia device comprises an optical disc player capable of playing audio compact discs.

6. The computerized system of claim 1, wherein the multimedia device comprises a tuner.

7. The computerized system of claim 1, wherein the multimedia device comprises an amplifier operatively coupled to at least one speaker.

8. A computerized system comprising:
a computer having at least a processor and a memory;
a multimedia device operatively coupled to the computer;
a pointing device having at least one control to control the multimedia device such that actuation of a control causes the computer to change a functionality associated with the control,
wherein the pointing device is operatively coupled to a corresponding port of the computer through which all communication between the pointing device and the computer occurs.

9. The computerized system of claim 8, wherein the multimedia device is selected from the group of multimedia devices comprising an amplifier operatively coupled to at least one speaker, a radio tuner, a television tuner, and an optical disc player capable of playing audio compact discs.

10. The computerized system of claim 8, wherein the pointing device is selected from the group of pointing devices comprising a mouse, a touch pad, a trackball, and a joystick.

11. The computerized system of claim 8, wherein at least one of the at least one control comprises a control selected from the group of controls consisting of a button, a slider, and a wheel.

12. A pointing device for a computer operatively coupled to a multimedia device, comprising:
a housing;
at least one mouse button disposed within the housing;
a component disposed within the housing to signal directional movement to the computer; and,
at least one control disposed within the housing to control the multimedia device.

13. The pointing device of claim 12, wherein actuation of a control causes the computer to change a functionality of the multimedia device associated with the multimedia control.

14. The pointing device of claim 12, wherein the pointing device is selected from the group of pointing devices comprising a mouse, a touch pad, a trackball, and a joystick.

15. The pointing device of claim 12, wherein at least one of the at least one control comprises a control selected from the group of controls consisting of a button, a slider, and a wheel.

16. A pointing device for a computer operatively coupled to a multimedia device comprising at least one control to control the multimedia device.

17. The pointing device of claim 16, wherein the pointing device is selected from the group of pointing devices comprising a mouse, a touch pad, a trackball, and a joystick.

18. The pointing device of claim 16, wherein actuation of a control causes the computer to change a functionality of the multimedia device associated with the control.
